(19) United States
(12) Patent Application Publication
(10) Pub. No.: US 2011/0008674 A1
(43) Pub. Date: Jan. 13, 2011

(54) SLAB LATTICE OF THE ORTHOPLUMBIC ACID BATTERY

(76) Inventor: Chun-Yi HONG, Suao Town (TW)

Correspondence Address: Muncy, Geissler, Olds & Lowe, PLLC, 4000 Legato Road, Suite 310, FAIRFAX, VA, 22033, US

(21) Appl. No.: 12/500,071

(22) Filed: Jul. 9, 2009

(51) Int. Cl. H01M 6/04

(52) U.S. Cl. 429/205

(57) ABSTRACT

A slab lattice of the orthoplumbic acid battery is able to decrease a occurrence rate of sulfation, wherein, the slab lattice of the battery provided multiple skeleton frames which substantially parallel to each other on the inner rim of the outer frame, and each skeleton frame is provided with a reaction chip, the width of the reaction chip is larger than the width of the skeleton frame substantially. As the slab lattice of the battery is soaking in solution, it increased the contact area with the solution and to improved the efficacity of the reaction. And restrainedly generate Non-activated material on the skeleton frame at the same time, therefor accomplished the efficacy of strengthening electric power storage, electrification and electrical discharge.

### BACKGROUND OF THE INVENTION

a) Field of the Invention

The present invention relates to a slab lattice of the orthoplumbic acid battery, and more particularly to a slab lattice of the orthoplumbic acid battery which is able to decrease the occurrence rate of sulfation, therefor to strengthening electric power storage, electrification and electrical discharge.

b) Description of the Prior Art

A battery jar which is used ordinarily in a car or motorcycle is a orthoplumbic acid battery, also known as a lead-acid battery, constituted by a positive pole slab lattice, a negative pole slab lattice, a partition plate, a battery cell, solution (usually dilute sulfuric acid (H₂SO₄)) and block terminals; wherein, the positive pole slab lattice soaked in sulfate is a lead dioxide (PbO₂) slab, the negative pole slab lattice which is soaked in sulfate is a lead (Pb) slab. Besides, many slab lattice of the lead-acid battery use lead antimony alloy which contained 4.2% antimony (Sb) or Lead-calcium alloy which contained 0.8% calcium (Ca).

When the orthoplumbic acid battery is electrical discharge, the lead of the negative pole will combine with sulfate ions in sulfate to form lead sulfate. The lead sulfate will be attached on the anode, and produced electrons at the same time; It means when soaking two slab lattice in the solution, it converted chemical energy into electric energy and outputted through block terminals. During the charging, the lead pole connected to the negative pole of the power, the lead dioxide pole connected to the positive pole of the power, and a direct current (DC) is put through between the two poles that a reverse reaction can be carrying out. Through the transformation between the chemical energy and the direct current (DC), which can be recharged after the electrical discharge, and able to use repeatedly.

Referring to FIG. 1, it shows a schematic view of a conventional battery slab lattice. As shown in the drawing, the battery slab lattice is a cast grid unit which includes an outer frame 10 and multiple skeleton frames 11 located inside the outer frame 10. During the chemical reaction when the battery is functioning, a few acidified substances of lead sulfate cannot be reduced and decomposed. This lead sulfate is hard and inactive, therefore, so-called sulfate crystals 12 will be formed and accumulated on the skeletons 11 gradually; this process is called sulfation or sulfurization, and the lead sulfate can be also called irreversible lead sulfate or hardened lead sulfate. After sulfation or sulfurization, a recharging or discharging resistance between the positive pole slab lattice and the negative pole slab lattice of the battery will increase, the crystals of the slab lattice will become coarser and harder and even an internal short-circuiting may occur; therefore, the lead sulfate cannot be dissolved by itself and the oxidation-reduction reaction cannot be carried out effectively after energizing the sulfated accumulator, thereby decreasing the capability of electric accumulator for reducing lead, and lowering down the activity as well. Furthermore, as the conventional slab lattice is thinner, it is easy to result in breakage by corrosion of sulfate solution, due to that the slab lattice is soaked in the sulfate solution for a long time.

On the other hand, after sulfating, a terminal voltage will drop quickly when the accumulator is discharging and can be much lower than a rated capacity of accumulation. On the contrary, the battery voltage will rise up more quickly when recharging; therefore, density of the solution cannot achieve a normal value, too much gas will be decomposed, battery temperature will be higher and the battery cannot be used normally.

### SUMMARY OF THE INVENTION

Accordingly, the primary object of the present invention is to provide a slab lattice of the orthoplumbic acid battery which can improve reaction efficiency between the slab lattice and sulfate solution of the orthoplumbic acid battery and can decrease a condition of sulfation or sulfurization, therefor strengthening electric power storage, electrification and electrical discharge.

To achieve the aforementioned object, the slab lattice of the orthoplumbic acid battery, according to the present invention, is soaked in solution to convert chemical energy into electric energy. The slab lattice is primarily assembled by an outer frame, multiple skeleton frames and reaction chips, wherein, the multiple skeleton frames are parallel provided at an inner rim of the outer frame and the reaction chips are provided on the skeleton frames, with the width of the reaction chip substantially larger than the width of skeleton frame. It can increase the contact area between the slab lattice and the solution of the orthoplumbic acid battery, which can restrainedly generate Non-activated material on the skeleton frame and decreases a occurrence rate of sulfation at a same time, therefor accomplished the efficacy of strengthening electric power storage, electrification and electrical discharge.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional slab lattice.

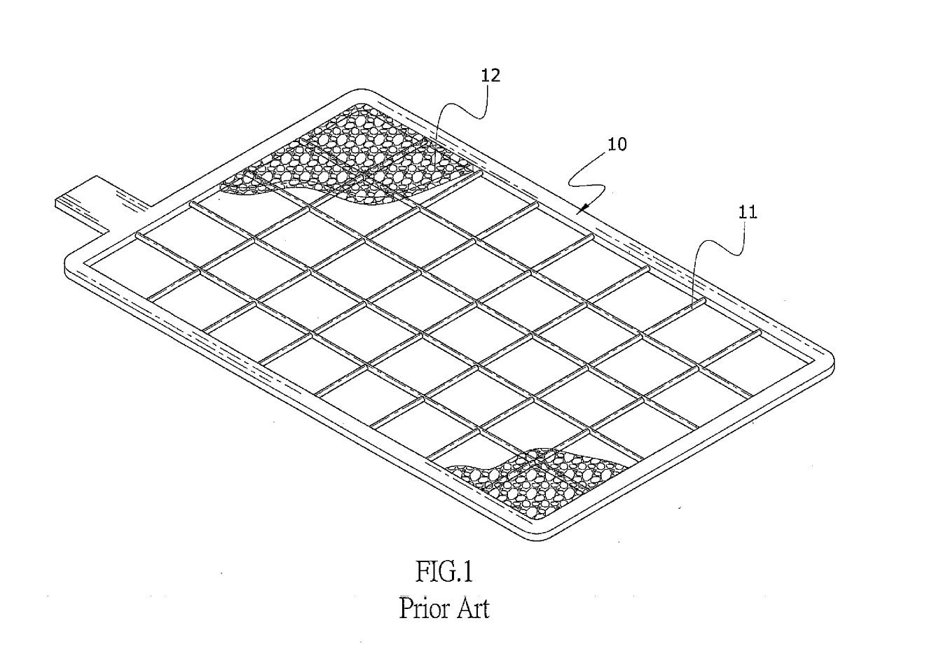

FIG. 2 shows a schematic view of a slab lattice of the orthoplumbic acid battery, according to the present invention.

FIG. 3 shows a schematic view of another embodiment of the present invention.

### DETAILED DESCRIPTION OF THE PREFERRED EMBODIMENTS

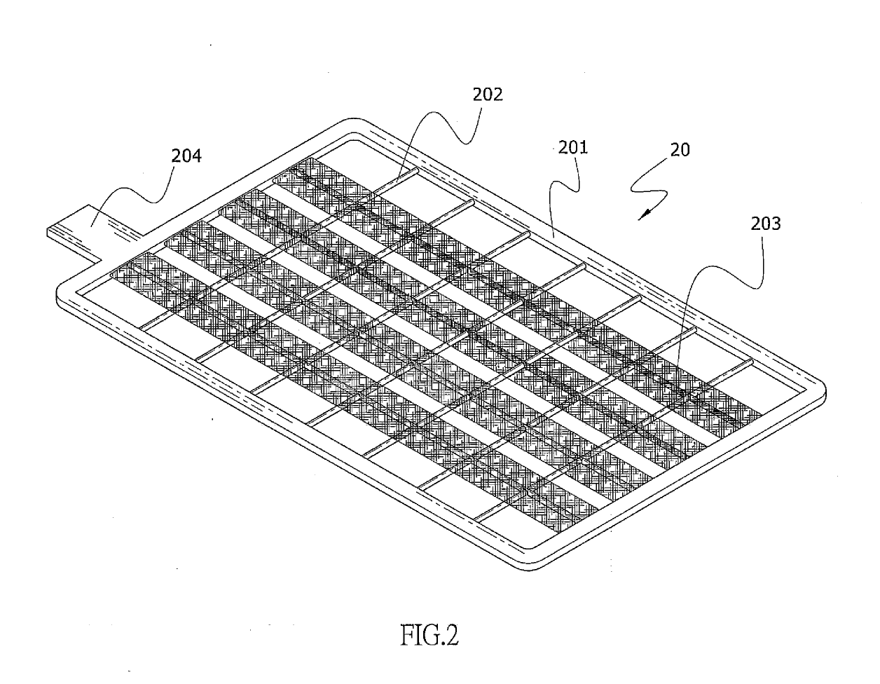

Referring to FIG. 2, it shows a schematic view of a slab lattice of the orthoplumbic acid battery, according to the present invention. As shown in the drawing, a slab lattice 20 of the orthoplumbic acid battery comprises an outer frame 201, multiple skeleton frames 202 and multiple reaction chips 203, wherein, the outer frame 201 and the skeleton frames 202 are manufactured by lead-tin alloy, the outer frame 201 is roughly a rectangular hollow unit, the multiple skeleton frames 202 are formed in roughly a long strip shape on an inner rim of the outer frame 201 along a longer side, and each skeleton frame 202 is substantially parallel with each other along the longer side. The multiple reaction chips 203 are plates of a flat surface roughly in a rectangular shape or plates of a non-flat surface, and are formed respectively on the multiple skeleton frames 202. The reaction chip 203 is primarily made by lead and the width of the reaction chip 203 is preferably to be larger than the the width of skeleton frame 202 substantially; whereas, it is preferable that the length of the reaction chip 203 is substantially smaller than t the length of skeleton frame 203. This means that every skeleton frame 202 is formed with one or more reaction chip 203. As shown in the drawing again, an outer rim of the outer frame 201 is formed with an electrode 204 which is roughly in a long strip shape.

Hereinbefore, the reaction chip 203 disclosed by the present embodiment is only for an example and is not to limit the structure of the reaction chip 203. The structure of the reaction chip 203 can be changed according to a practical requirement, such as that the reaction chip 203 can cross over two stripes of skeleton frames 202 at a same time that the two stripes of skeleton frames 202 are connected, the length of the reaction chip 203 can be between the inner rims of the skeleton frames 202, two ends of the reaction chip 203 can be connected respectively at the inner rim of the outer frame 201, or the width of the reaction chip 203 can be equal to the width of the skeleton frame 202. On the other hand, the aforementioned outer frame 201, multiple skeleton frames 202, multiple reaction chips 203 and electrode 204 are preferably made by lead (Pb). However, this not limited by the present invention, and the material can include metal or metalloid, such as magnesium (Mg), boron (B), aluminum (Al), calcium (Ca), indium (In), silicon (Si), germanium (Ge), tin (Sn), bismuth (Bi), alimony (Sb), silver (Ag), zinc (Zn), hafnium (Hf), zirconium (Zr), yttrium (Y), palladium (Pd) or platinum (Pt), disregarding whether a crystal or non-crystal.

When the slab lattice 20 of the orthoplumbic acid battery, according to the present invention, is soaked in solution, such as sulfate solution, chemical energy will be converted into electric energy through a chemical reaction. Furthermore, by a large area that the reaction chip 203 is provided with, a contact and reaction area between the reaction chip 203 and the sulfate solution can be increased significantly. As a result, during a chemical reaction of charging or discharging, Non-activated material can be restrainedly generate from skeleton frames 202, which decreases the occurrence rate of sulfation or sulfurization, effectively solves the issues existing in the conventional orthoplumbic acid battery that internal short-circuiting may occur and impedance may increase by sulfation or sulfurization and intensifies capabilities of the orthoplumbic acid battery for electric power storage, electrification and electrical discharge, thereby extending a lifetime of usage of the orthoplumbic acid battery. On the other hand, to increase the contact area between the slab lattice 20 of the orthoplumbic acid battery and the solution, the reaction chip 203 can be made into a slab of a curve surface, and a surface of the reaction chip 203 can be in an irregular shape or rough shape, such as a saw-tooth shape.

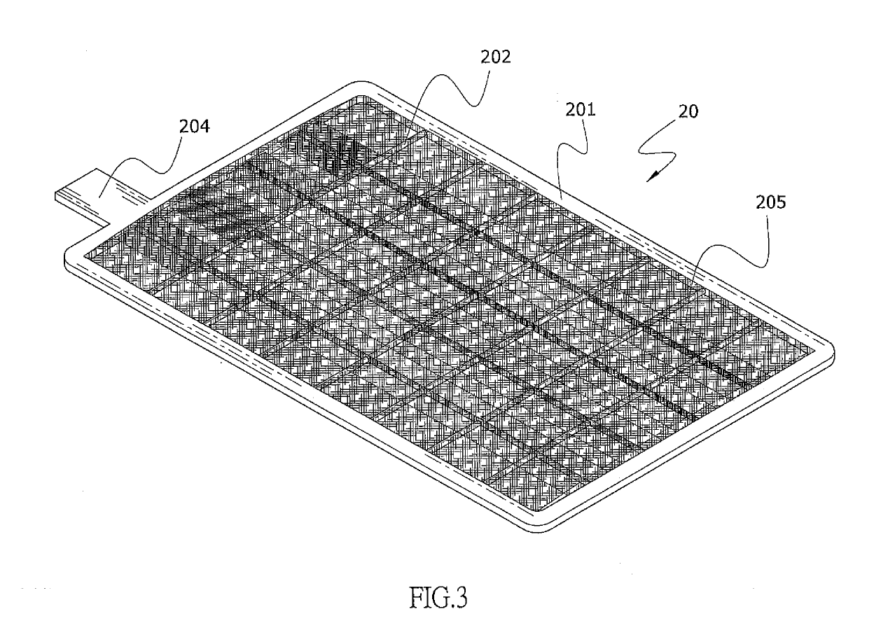

Referring to FIG. 3, it shows a schematic view of another embodiment of the present invention. As shown in the drawing, the present embodiment further forms the entire structure into a plate-shape to constitute a complete reaction surface 205. In the present embodiment, the reaction surface 205 is a plate of a flat surface roughly in a rectangular shape and can be coated on a surface of each reaction chip 203. Moreover, a size of the reaction surface 205 can be between the reaction chip 203 and the outer frame 201, wherein the size of the reaction surface 205 is preferably to be equal to a size of the outer frame 201 substantially, so as to connect and enclose all the reaction chips 203. In addition, in the present embodiment, when the slab lattice 20 of the orthoplumbic acid battery, according to the present invention, is soaked in solution such as sulfate, better charging or discharging efficiency can be available by that the reaction surface 205 is provided with a larger contact area with the solution than the previous embodiment.

Concluding above, the slab lattice of the orthoplumbic acid battery, according to the present invention, is formed primarily with the reaction chip to increase the reaction area and accelerate the reaction efficiency with the sulfate solution, thereby shortening a charging time of the orthoplumbic acid battery. Accordingly, after implementing the present invention, it can actually provide a slab lattice of a orthoplumbic acid battery which is able to improve the reaction efficiency between the slab lattice and the sulfate solution of the orthoplumbic acid battery and to decrease sulfation at a same time, therefor accomplished the efficacy of strengthening electric power storage, electrification and electrical discharge.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A slab lattice of the orthoplumbic acid battery which is soaked in sulfate solution to result in a chemical reaction between the slab lattice and the sulfate solution, comprising an outer frame; multiple skeleton frames which are located at an inner rim of the outer frame; and multiple reaction chips which are formed in a plate-shape on the multiple skeleton frames to increase a reaction area between the sulfate solution.

2. The slab lattice of the orthoplumbic acid battery according to claim 1, wherein the reaction chips are connected to the neighboring skeleton frames.

3. The slab lattice of the orthoplumbic acid battery according to claim 1, wherein the width of the reaction chip is substantially larger than the width of skeleton frame.

4. The slab lattice of the orthoplumbic acid battery according to claim 1, wherein the length of the reaction chip is substantially smaller than or equal to the skeleton frame.

5. The slab lattice of the orthoplumbic acid battery according to claim 1, wherein multiple electrodes are formed at an outer rim of the outer frame.

6. The slab lattice of the orthoplumbic acid battery according to claim 1, wherein one reaction surface encloses completely the skeleton frames.

7. The slab lattice of the orthoplumbic acid battery according to claim 6, wherein a size of the reaction surface is substantially same as the outer frame.

8. The slab lattice of the orthoplumbic acid battery according to claim 6, wherein the reaction surface is a plate of a flat surface.

9. The slab lattice of the orthoplumbic acid battery according to claim 6, wherein the reaction surface is a plate of an irregular surface.

10. The slab lattice of a orthoplumbic acid battery according to claim 6, wherein the reaction surface is a plate of a curved surface.

11. The slab lattice of the orthoplumbic acid battery according to claim 6, wherein the reaction surface is in a saw-tooth shape.
